(19) United States
(12) Patent Application Publication
(10) Pub. No.: US 2024/0280847 A1
(43) Pub. Date: Aug. 22, 2024

(54) A TOUCH SENSING DISPLAY AND TOUCH SENSING APPARATUS

(71) Applicant: Flatfrog Laboratories AB, Lund (SE)

(72) Inventors: Aleksander Kocovski, Malmö (SE); Ola Wassvik, Lammhult (SE)

(21) Appl. No.: 18/566,918

(22) PCT Filed: Jun. 10, 2022
(86) PCT No.: PCT/SE2022/050575

§ 371 Date: Dec. 4, 2023

(30) Foreign Application Priority Data
Jun. 11, 2021 (SE) 2130161-9

(51) Int. Cl. G02F 1/1333; G06F 3/042

(52) U.S. Cl. CPC G02F 1/133314; G02F 1/13338; G06F 3/0421; G06F 3/0428

(57) ABSTRACT

A touch sensing display comprises a frame comprising at least one surface mounting. The touch sensing display also comprises a panel defining a touch surface on a first side and being mounted to the frame around a periphery of the panel. The touch sensing display further comprises at least one touch detector configured to detect a touch event on the touch surface. A display apparatus is mounted to the frame and facing rear surface on a second side of the panel. The display apparatus is configured to receive a touch event signal from the at least one touch detector. The frame is load bearing and arranged to support the weight of the touch sensing display when the at least one surface mounting is attached to a surface.

### TECHNICAL FIELD

The present disclosure relates to a touch sensing display and touch sensing apparatus for use with a display apparatus.

### BACKGROUND

Known touch sensing displays comprise a touch sensing panel which is mounted to display. The display device and the touch sensing panel are fixed to a back plate which is a rigid and holds the display device and the touch sensing panel in place. The back plate is made from steel or another stiff material and is mounted to a wall or a stand.

A problem with known touch sensing displays is that they are very heavy and require several people to install on a wall or stand. This means that installation is time consuming and difficult and often cannot be performed by a single user. Instead the user may need to engage professional contractors to install the heavy touch sensing displays. This is inconvenient if the touch sensing display needs to be moved or installed quickly.

### SUMMARY

Examples of the present disclosure aim to address the aforementioned problems.

According to an aspect of the present disclosure there is a touch sensing display comprising: a frame comprising at least one surface mounting; a panel defining a touch surface on a first side and being mounted to the frame around a periphery of the panel; at least one touch detector configured to detect a touch event on the touch surface; and a display apparatus mounted to the frame and facing rear surface on a second side of the panel, the display apparatus being configured to receive a touch event signal from the at least one touch detector; wherein the frame is load bearing and arranged to support the weight of the touch sensing display when the at least one surface mounting is attached to a surface.

Optionally, the panel is fixed to the frame and both the frame and the panel are load bearing and arranged to support the weight of the touch sensing display when the at least one surface mounting is attached to the surface.

Optionally, the panel is fixed to the frame along a periphery of the panel and on the rear surface on the second side of the panel.

Optionally, a back plate is mounted to the frame such that the display apparatus is between the panel and the back plate.

Optionally, the back plate is fixed to the frame and both the frame and the back plate are load bearing and arranged to support the weight of the touch sensing display when the at least one surface mounting is attached to the surface.

Optionally, the frame and/or the back plate is made from carbon fibre and/or aluminum.

Optionally, at least one tensioning connecting element is mounted between a first part of the frame and a second part of the frame and arranged to fix the first part of the frame with respect to the second part of the frame.

Optionally, the first part of the frame and the second part of the frame are positioned on different sides of the frame.

Optionally, the frame comprises a projecting lip configured to engage the one or more internal components and the projecting lip is configured to clamp the one or more internal components against the touch panel.

Optionally, one or more internal components are the display apparatus and/or the at least one touch detector.

Optionally, the at least one touch detector is a plurality of light emitters and detectors arranged along a perimeter of the panel and the light emitters are arranged to emit a respective beam of emitted light above the touch surface, and the light emitters are arranged to receive detection light from the emitted light.

Optionally, the plurality of touch detectors are mounted on a substrate and the substrate is mounted within a slot in the frame.

Optionally, the at least one touch detector is a projected capacitive touch assembly.

Optionally, the at least one surface mounting comprises a mounting bracket fixed to the frame.

Optionally, the mounting bracket comprises one or more mounting positions for receiving a fastening and/or a hanging cable.

Optionally, the mounting bracket is a VESA mounting adapter.

Optionally, the surface is an upright surface.

Optionally, the frame comprises at least one interlocking corner comprising a first interlocking corner part and a second interlocking corner part.

Optionally, the first interlocking corner part and the second interlocking corner parts each comprise at least one first engagement surface in a first plane and at least one second engagement surface in a second plane perpendicular to the first plane.

Optionally, the first interlocking corner part and the second interlocking corner part each comprise a first overlapping tab and a second overlapping tab wherein the first overlapping tab is on a front facing side of the frame and the second overlapping tab is positioned on a rear facing side of the frame.

Optionally, the first interlocking corner part and the second interlocking corner part comprise at least one hole for receiving one or more locking fasteners therethrough.

In another aspect of the disclosure there is a touch sensing apparatus, comprising: a frame comprising at least one surface mounting; a panel defining a touch surface on a first side and being mounted to the frame around a periphery of the panel; at least one touch detector configured to detect a touch event on the touch surface; and at least one a display apparatus mounting fixed to the frame and configured to mount a display apparatus to the frame and facing rear surface a second side of the panel, the display apparatus being configured to receive a touch event signal from the at least one touch detector; wherein the frame is load bearing and arranged to support the weight of the touch sensing apparatus when the at least one surface mounting is attached to a surface.

In yet another aspect of the disclosure there is provided a touch sensing apparatus comprising: a frame having a channel; a panel defining a touch surface on a first side and being mounted to the frame above the channel around a periphery of the panel; a plurality of light emitters and detectors arranged along a perimeter of the panel and the light emitters are arranged to emit a respective beam of emitted light above the touch surface, and the light emitters are arranged to receive detection light from the emitted light; a substrate on which the plurality of light emitters and detectors are mountable wherein the substrate is mountable in the channel; and a sealing guide mountable in the channel and configured to seal the channel.

Optionally, the sealing guide is light transmissive and mounted between the plurality of light emitters and detectors and the panel.

Optionally, the sealing guide is arranged to engage the substate when mounted in the channel.

Optionally, the sealing guide is arranged to urge the substrate against one or more walls of the channel when mounted in the channel.

Optionally, the sealing guide comprises a slot and rail arranged to respectively engage with a reciprocal rail and slot arrangement on the frame.

### BRIEF DESCRIPTION OF THE DRAWINGS

Various other aspects and further examples are also described in the following detailed description and in the attached claims with reference to the accompanying drawings, in which:

FIG. 1a shows a schematic side view of a touch sensing apparatus according to an example;

FIG. 1b shows a schematic plan view of a touch sensing apparatus according to an example;

FIG. 2 shows schematic view of a touch sensing display according to an example;

FIG. 3 shows a rear perspective view of a touch sensing display according to an example;

FIG. 4 shows a partial perspective view of a frame of a touch sensing display according to an example;

FIG. 5 shows a partial cross sectional view of a touch sensing display according to an example;

FIG. 6 shows a rear perspective view of a touch sensing display according to an example;

FIG. 7 shows a partial perspective view of a touch sensing display according to an example;

FIG. 8 shows a partial cross sectional view of a touch sensing display according to an example;

FIG. 9 shows a rear view of a touch sensing display according to an example;

FIG. 10 shows a rear view of a touch sensing display according to an example;

FIG. 11 shows a partial cross sectional view of a touch sensing apparatus according to an example;

FIG. 12 shows a partial cross sectional view of a touch sensing display according to an example;

FIG. 13 shows a partial cross sectional view of a touch sensing display according to an example;

FIG. 14a shows a front view of a touch sensing display according to an example;

FIGS. 14b-c show side views of a touch sensing display according to an example;

FIGS. 15a-c show top-down views of a touch sensing display when mounted to a mounting surface according to an example;

FIG. 16a shows a front view of a touch sensing display according to an example; and FIGS. 16b-c show side views of a touch sensing display according to an example;

### DETAILED DESCRIPTION

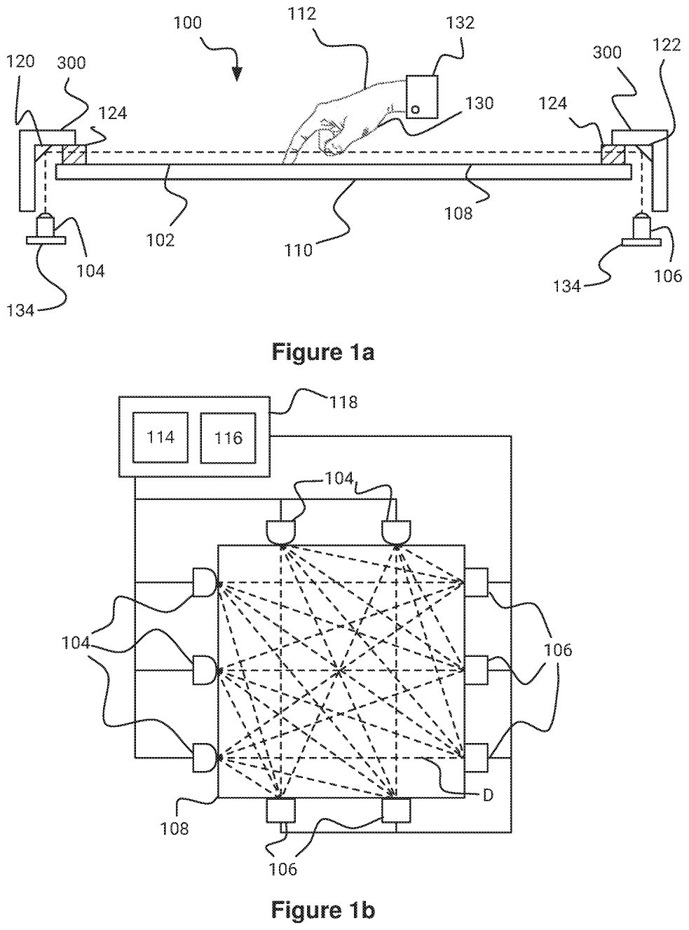

FIGS. 1a and 1b illustrate an optional example of a touch sensing apparatus 100 known as ‘above surface optical touch systems’. Whilst the touch sensing apparatus 100 as shown and discussed in reference to FIGS. 1a and 1b can be an above surface optical touch system, alternative touch sensing technology can be used.

For example, the examples discussed with reference to the Figures can be applied to any other above surface optical touch system configuration as well as non-above surface optical touch system types which perform touch detection in frames.

In some examples the touch sensing apparatus 100 can use one or more of the following including: frustrated total internal reflection (FTIR), resistive, surface acoustic wave, capacitive, surface capacitance, projected capacitance, above surface optical touch, dispersive signal technology and acoustic pulse recognition type touch systems. The touch sensing apparatus 100 can be any suitable apparatus for detecting touch input from a human interface device.

The touch sensing apparatus 100 will now be discussed in reference to FIG. 1a and FIG. 1b. FIG. 1a shows a schematic side view of a touch sensing apparatus 100. FIG. 1b shows a schematic top view of a touch sensing apparatus 100.

The touch sensing apparatus 100 comprises a set of optical emitters 104 which are arranged around the periphery of a touch surface 108. The optical emitters 104 are configured to emit light that is reflected to travel above a touch surface 108. A set of optical detectors 106 are also arranged around the periphery of the touch surface 108 to receive light from the set of optical emitters 104 from above the touch surface 108. An object 112 that touches the touch surface 108 will attenuate the light on one or more propagation paths D of the light and cause a change in the light received by one or more of the optical detectors 106. The location (coordinates), shape or area of the object 112 may be determined by analysing the received light at the detectors.

In some examples, the optical emitters 104 are optionally arranged on a substrate 134 such as a printed circuit board, and light from the optical emitters 104 travel above the touch surface 108 of a touch panel 102 via reflection or scattering on an edge reflector/diffusor 120. The emitted light may propagate through an optional light transmissive sealing window 124.

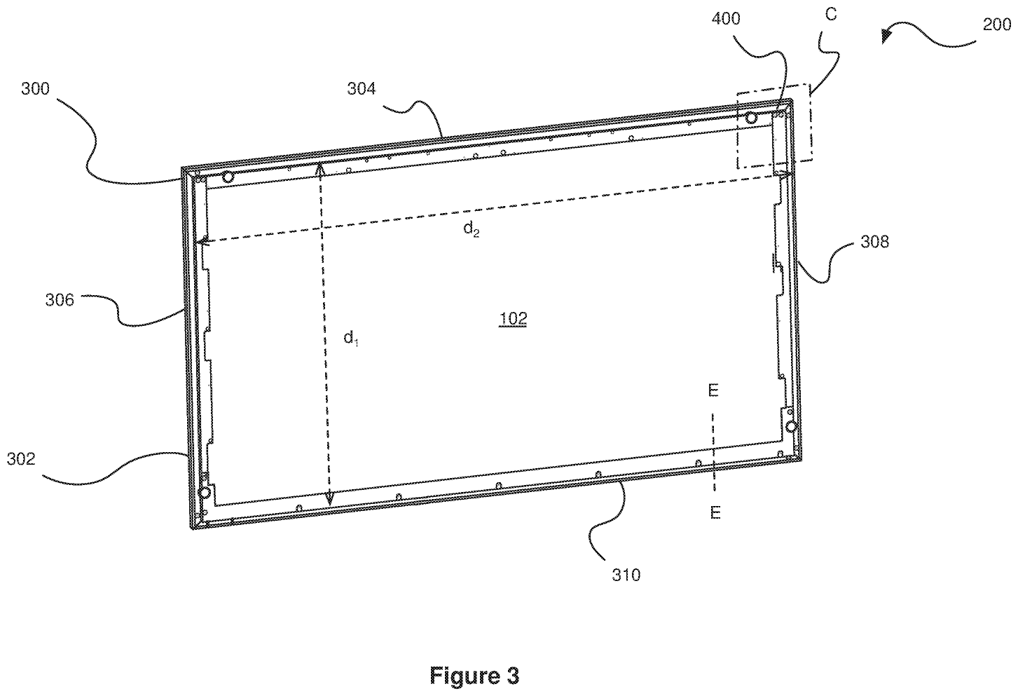

The optional light transmissive sealing window 124 allows light to propagate therethrough but prevents ingress of dirt into a frame 300 (as best shown in FIG. 3) where the electronics and other components are mounted. The light will then continue until deflected by a corresponding edge reflector/diffuser 120 at an opposing edge of the touch panel 102, where the light will be scattered back down around the touch panel 102 and onto the optical detectors 106. The touch panel 102 can be a light transmissive panel for allowing light from a display device 204 propagating therethrough.

In some examples the touch panel 102 is a sheet of glass. Alternatively, in some other examples, the touch panel 102 is a sheet of any suitable light transmissive material such as polymethyl methacrylate, or any other suitable light transmissive plastic material.

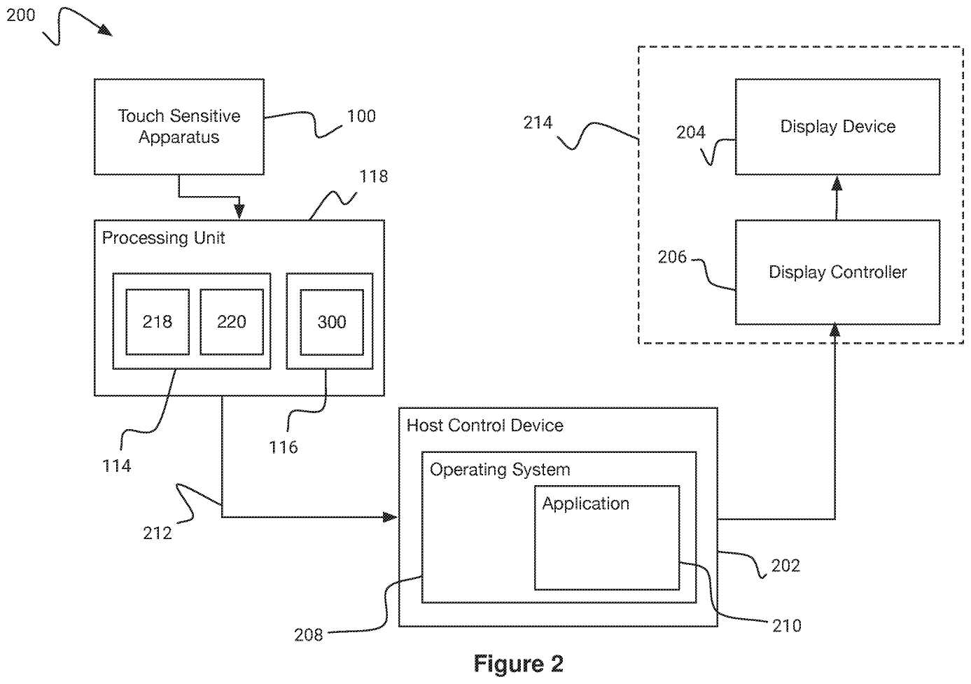

In this way, the touch sensing apparatus 100 comprising the light transmissive touch panel 102 may be designed to be overlaid on or integrated into a display apparatus 214 (best shown in FIG. 2). This means that the display device 204 can be viewed through the touch panel 102 when the touch panel 102 is overlaid on the display device 204.

The touch sensing apparatus 100 allows an object 112 that is brought into close vicinity of, or in contact with, the touch surface 108 to interact with the propagating light at the point of touch. In FIG. 1a, the object 112 is a user's hand, but additionally or alternatively is e.g. a pen (not shown). In this interaction, part of the light may be scattered by the object 112, part of the light may be absorbed by the object 112, and part of the light may continue to propagate in its original direction over the touch panel 102.

The optical detectors 106 collectively provide an output signal, which is received and sampled by a signal processor unit 114. The output signal may contain a number of sub-signals, also denoted “projection signals”, each representing the energy of light emitted by a certain optical emitter 104 and received by a certain optical detector 106. Depending on implementation, the signal processor unit 114 may need to process the output signal for separation of the individual projection signals. Conceptually, the touch sensing apparatus 100 is considered to define a grid of detection lines D on the touch surface 108, where each detection line D corresponds to a light propagation path from an optical emitter 104 to an optical detector 106, as projected onto the touch surface 108. Thus, the projection signals represent the received energy or power of light on the individual detection lines D. It is realized that the touching object 112 results in a decrease (attenuation) of the received energy on one or more detection lines D.

The signal processor unit 114 may be configured to process the projection signals so as to determine a distribution of signal strength values (for simplicity, referred to as a “touch surface pattern”) across the touch surface 108, where each signal strength value represents a local attenuation of light. The signal processor unit 114 is configured to carry out a plurality of different signal processing steps in order to extract touch data for at least one object. Additional signal processing steps may involve filtering, back projection, smoothing, and other post-processing techniques as described in WO 2011/139213, which is incorporated herein by reference. In some examples the filtering and smoothing of the reconstructed touch data is carried out by a filtering module 220 as shown in FIG. 2. The signal processing is known and will not be discussed in any further detail for the purposes of brevity.

Turning back to FIG. 1b, in the illustrated example the touch sensing apparatus 100 also includes a controller 116 which is connected to selectively control the activation of the optical emitters 104 and, possibly, the readout of data from the optical detectors 106. The signal processor unit 114 and the controller 116 may be configured as separate units, or they may be incorporated in a single unit. One or both of the signal processor unit 114 and the controller 116 may be at least partially implemented by software executed by a processing unit 118. In some examples the processing unit 118 can be a touch controller. The reconstruction module 218 and filtering module 220 of the signal processor unit 114 may be configured as separate units, or they may be incorporated in a single unit. One or both of the reconstruction module 218 and filtering module 220 may be at least partially implemented by software executed by the signal processing unit 114 or the processing unit 118.

The relationship between the touch sensing apparatus 100 and a display apparatus 214 will now be discussed in reference to FIG. 2. FIG. 2 shows a schematic representation of a touch sensing display 200.

The touch sensing display 200 comprises the touch sensing apparatus 100 and a display apparatus 214. The display apparatus 214 comprises a display device 204 and may comprise a display controller 206 which is configured to display the output from a host control device 202. In some examples, the display controller 206 can be integrated into the display apparatus 214. Alternatively, the display controller 206 can be separate from the display apparatus 214. In some examples, the display controller 206 can be incorporated into the processing unit 118.

The display device 204 can be any suitable device for visual output for a user such as a monitor. The display device 204 is controlled by the display controller 206. Display devices 204 and display controllers 206 are known and will not be discussed in any further depth for the purposes of expediency.

In some examples, the display device 204 comprises a plurality of layers such as filters, diffusers, backlights and liquid crystals. Additional or alternative components can be provided in the plurality of layers depending on the type of display device 204. In some examples, the display device is an LCD, a quantum dot display, an LED backlit LCD, a WLCD, an OLCD, a plasma display, an OLED, a transparent OLED, a POLED, an AMOLED and/or a Micro LED. In other examples, any other suitable display device 204 can be used in the touch sensing display 200.

The host control device 202 may be connectively coupled to the touch sensing apparatus 100. The host control device 202 receives output from the touch sensing apparatus 100. In some examples the host control device 202 and the touch sensing apparatus 100 are connectively coupled via a data connection 212 such as a USB connection. In other examples other wired or wireless data connection 212 can be provided to permit data transfer between the host control device 202 and the touch sensing apparatus 100. For example, the data connection 212 can be ethernet, firewire, Bluetooth, Wi-Fi, universal asynchronous receiver-transmitter (UART), or any other suitable data connection. In some examples there can be a plurality of data connections between the host control device 202 and the touch sensing apparatus 100 for transmitting different types of data. The touch sensing apparatus 100 detects a touch object when a physical object is brought in sufficient proximity to, a touch surface 108 so as to be detected by one or more optical detector 106 in the touch sensing apparatus 100. The physical object may be animate or inanimate. In preferred examples the data connection 212 is a human interface device (HID) USB channel. The data connection 212 can be a logical or physical connection.

In some examples the touch sensing apparatus 100, the host control device 202 and the display device 204 are integrated into the same touch sensing display 200 such as a laptop, tablet, smart phone, monitor or screen. In other examples, the touch sensing apparatus 100, the host control device 202 and the display device 204 are separate components. For example, the touch sensing apparatus 100 can be a separate component mountable on a display screen.

In some examples, the touch sensing display 200 comprises a modular construction and the display apparatus 214 is mountable to the touch sensing apparatus 100. This means that the touch sensing apparatus 100 and the display apparatus 214 can be manufactured separately and then assembled together.

Accordingly in some examples, the touch sensing apparatus 100 comprises at least one a display apparatus 214 mounting fixed to a frame 300 and configured to mount the display apparatus 214 to the frame 300. The assembled touch sensing display 200 is provided when the display apparatus 214 is mounted to touch sensing apparatus 100.

The host control device 202 may comprise an operating system 208 and one or more applications 210 that are operable on the operating system 208. The one or more applications 210 are configured to allow the user to interact with the touch sensing apparatus 100 and the display device 204. The operating system 208 is configured to run the one or more applications 210 and send output information to the display controller 206 for displaying on the display device 204. The applications 210 can be drawing applications or whiteboards applications for visualising user input. In other examples the applications 210 can be any suitable application or software for receiving and displaying user input.

Turning to FIG. 3, the touch sensing display 200 will be discussed in more detail. The touch sensing display 200 comprises the frame 300. The frame 300 is positioned around a periphery 302 of the touch sensing display 200. In some examples, the frame 300 comprises a plurality of frame parts which are assembled together to form the frame 300 as shown in FIG. 3.

As shown in FIG. 3, the touch panel 102 is mounted to the frame 300. The touch panel 102 as shown in FIG. 3 comprises a rectangular shape and the frame 300 is mounted to the touch panel 102 on each side of the touch panel 102 around the periphery 302 of the touch panel 102.

In some examples, the frame 300 comprises a first frame part 304, a second frame part 306, a third frame part 308 and a fourth frame part 310. The touch sensing display 200 as shown in FIG. 3 comprises a landscape orientation. This means that the first frame part 304 is positioned on the top of the touch sensing display 200, the second frame part 306 is positioned on a left hand side of the touch sensing display 200, the third frame part 308 positioned on a right hand side of the touch sensing display 200 and the fourth frame part 310 is positioned on the bottom of the touch sensing display 200. If the touch sensing display 200 is mounted in a different orientation e.g. in a portrait orientation, then the first, second, third and fourth frame parts 304, 306, 308, 310 may be positioned differently.

In some examples, the first, second, third and fourth frame parts 304, 306, 308, 310 comprise the same cross-sectional profile. This means that the first, second, third and fourth frame parts 304, 306, 308, 310 can be mounted to the other parts of the touch sensing display 200 the same way. This also means that the first, second, third and fourth frame parts 304, 306, 308, 310 can be manufactured the same way e.g. extruded through a die.

The first, second, third and fourth frame parts 304, 306, 308, 310 are fixed together to form a rigid structure. The frame 300 provides the supporting structure for mounting the components and parts of the touch sensing display 200. This means that the frame 300 is load bearing and supports the weight of the touch sensing display 200 when mounted to a surface. In some examples, the touch sensing display 200 is mounted to a vertical surface such as to a wall (shown), or a display stand (not shown). In some other examples, the touch sensing display 200 can be mounted to a surface inclined to a vertical plane.

The first, second, third and fourth frame parts 304, 306, 308, 310 in some examples are bolted together. In some alternative examples, the first, second, third and fourth frame parts 304, 306, 308, 310 are fixed together with any suitable fastenings. A plurality of fastenings can be used between the first, second, third and fourth frame parts 304, 306, 308, 310 to increase the rigidity of the assembled frame 300. In some examples, the first, second, third and fourth frame parts 304, 306, 308, 310 can be welded or bonded together. Indeed any suitable fastening, adhesive or bonding can be used to securely couple the first, second, third and fourth frame parts 304, 306, 308, 310 together.

In some examples, the display device 204 and the touch panel 102 are mounted to the frame 300. When the touch sensing display 200 is mounted on a wall, the frame 300 is load bearing and supports the weight of the touch panel 102 and the display device 204 whilst maintaining their relative positions to each other and other components of the touch sensing display 200.

This means that the first, second, third and fourth frame parts 304, 306, 308, 310 are fixed with respect to each other and do not move when the frame 300 is place under a load. Accordingly, there is no translational, rotational or other movement of one frame part with respect to another frame part. For example, when the frame 300 is assembled, the first frame part 304 and the fourth frame parts 310 remain separated from each other by a fixed distance d₁. Similarly, when the frame 300 is assembled, the second frame part 306 and the third frame parts 308 remain separated from each other by a fixed distance d₂.

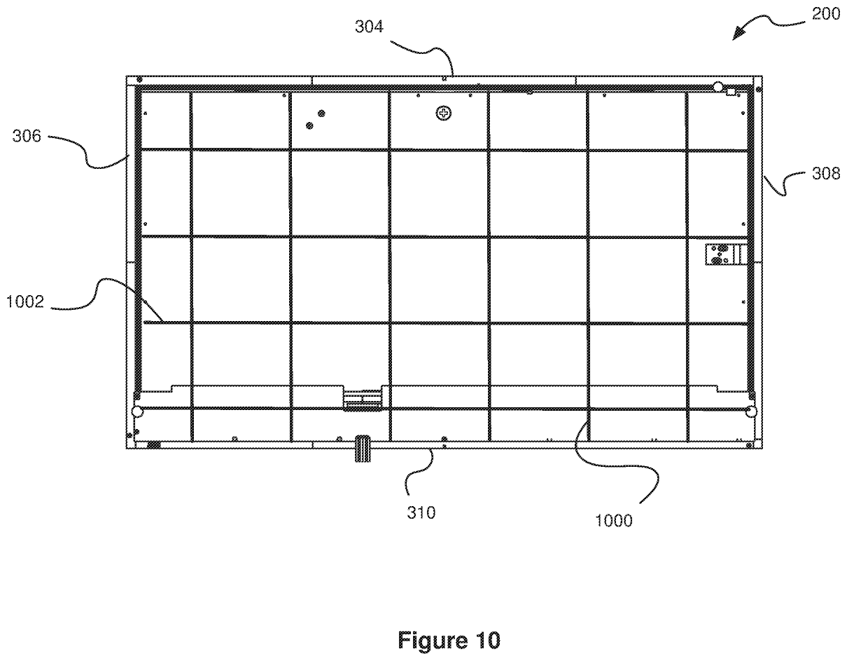

The frame 300 is rigid and the first, second, third and fourth frame parts 304, 306, 308, 310 remain straight when assembled. This means that the frame 300 remains a rectangular shape and the individual frame parts 304, 306, 308, 310 do not deform at any point along their length under load. In some examples the first, second, third and fourth frame parts 304, 306, 308, 310 are fixed together at the corners 400 of the frame 300. In some other examples, the first, second, third and fourth frame parts 304, 306, 308, 310 are fixed together at other parts along their length. For example, there can be one or more connected elements coupled between one or more of the first, second, third and fourth frame parts 304, 306, 308, 310. This is discussed in further detail in reference to FIG. 10 below.

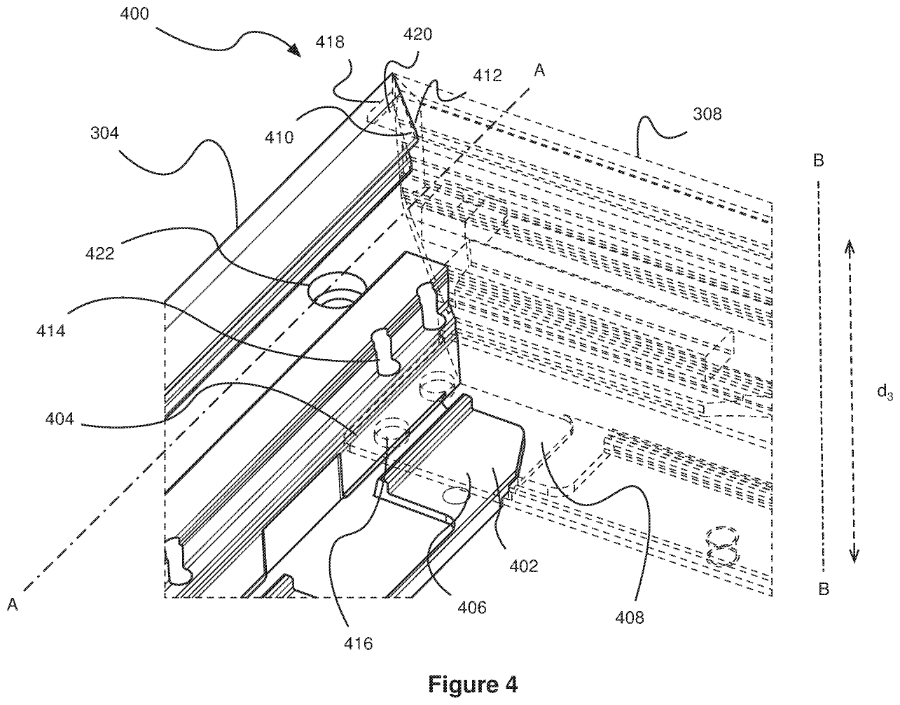

The frame 300 will now be discussed in more detail in reference to FIG. 4. FIG. 4 shows a partial perspective view of the frame 300 of the touch sensing display 200 according to an example. FIG. 4 is a close-up of the frame 300 in the area of the frame 300 as shown by the dotted box labelled C.

FIG. 4 shows a corner 400 of the frame 300. The corner 400 is formed from the combination of first frame part 304 and the third frame part 308. For the purposes of clarity, the third frame part 308 has been shown with dotted lines. Although FIG. 4 shows only one corner 400 of the frame 300, each of the other corners 400 in the frame 300 comprises a similar structure.

In some examples, the first frame part 304 and the third frame part 308 each optionally comprise a mitred edge which engage with each other to form the corner 400 via a mitred joint. The ends of the first frame part 304 and the third frame part 308 are each formed with a 45° angle with respect to a longitudinal axis A-A (shown for the first frame part 304 only in FIG. 4) along the mitred end. Alternatively, in some other examples which are not shown, the first frame part 304 and the third frame part 308 each optionally comprise a straight end which engage with each other to form the corner 400 via a butted joint. The ends of the first frame part 304 and the third frame part 308 are each formed with a 90° angle with respect to a longitudinal axis A-A to from the straight end.

The first frame part 304 and the third frame part 308 in some examples are interlocking. The interlocking arrangement between the first frame part 304 and the third frame part 308 is provided by one or more overlapping elements. In some examples, the first frame part 304 comprises a first interlocking corner part 402 and the third frame part 308 comprises a second interlocking corner part 404. The first and second interlocking corner parts 402, 404 respectively comprises a first engagement surface 406 and a second engagement surface 408. The first and second engagement surfaces 406, 408 are arranged to abut against each other when the first frame part 304 and the third frame part 308 are assembled. The first and second engagement surfaces 406, 408 increase the frictional forces between the first frame part 304 and the third frame part 308. This means that first frame part 304 and the third frame part 308 as less likely to move with respect to each other once assembled.

In some examples, the first and second engagement surfaces 406, 408 are arranged in a first plane parallel with the plane of the touch panel 102.

In some examples, the first frame part 304 and the third frame part 308 respectively comprises a third engagement surface 410 and a fourth engagement surface 412. In some examples, the third engagement surface 410 and the fourth engagement surface 412 are arranged in a second plane perpendicular to the plane of the touch panel 102.

This means that the first frame part 304 and the third frame part 308 engage each other in two different perpendicular planes. This means that the corner 400 is rigid and better resistant to relative movement (such as rotational or translational movement) of the first frame part 304 and the third frame part 308 in two different directions.

In some examples the first and second engagement surfaces 406, 408 and the third and fourth engagement surfaces 410, 412 can be adhered together with adhesive. Additionally or alternatively, fastenings are provided to fix the first and third frame parts 304, 308 together.

The first and third frame parts 304, 308 optionally comprise holes 414, 416 for receiving fastenings such as a screw or bolt. In some examples one or both of the holes 414, 416 comprise a screw thread for engaging with a screw fastening (not shown). Alternatively, in some other examples, the holes 414, 416 do not have a screw thread and the screw fastening engages with a separate nut (not shown). In some other examples any suitable fixing or fastening can be used to fix the first frame part 304 to the third frame part 308.

As shown in FIG. 4 the first and second interlocking corner parts 402, 404 are projecting tabs and overlap each other. However, in other examples, the first and second interlocking corner parts 402, 404 can comprise a slot and tab arrangement. That is a tab of the first interlocking corner part 402 is inserted into a reciprocal slot of the second interlocking corner part 404. A slot and tab arrangement may advantageous because both the tab and slot comprise two engagement surfaces and thereby increase the frictional forces therebetween.

In some examples, the first and third frame parts 304, 308 optionally comprise one or more additional interlocking corner parts. For example, as shown in FIG. 4, In some examples, the first frame part 304 comprises a third interlocking corner part 418 and the third frame part 308 comprises a fourth interlocking corner part 420. The third and fourth interlocking corner parts 418, 420 are similar to the previously discussed first and second interlocking corner parts 402, 404.

In some examples, the first interlocking corner part 402 and the second interlocking are separated from the third interlocking corner part 418 and fourth interlocking corner part 420 by a distance ds along an axis B-B perpendicular to the plane of the touch panel 102. This means that the first frame part 304 and the third frame part 308 are better resistant to rotational movement with respect to each other.

In some alternative embodiments, the corner 400 may optionally comprises a friction fit joint between the first frame part 304 and the third frame part 308. The friction fit joint is arranged such that the first interlocking corner part 402, the second interlocking, the third interlocking corner part 418 and the fourth interlocking corner part 420 secure together without adhesive or fastenings. Accordingly, the corner 400 may comprise dovetail joints between the first interlocking corner part 402 and the second interlocking and between the third interlocking corner part 418 and the fourth interlocking corner part 420. The dovetail joint will resist the separation between the first frame part 304 and the third frame part 308. In some examples, the friction fit joint is used in combination with adhesive, bonding and/or fasteners to further increase the securing force at the corner 400 between the first frame part 304 and the third frame part 308.

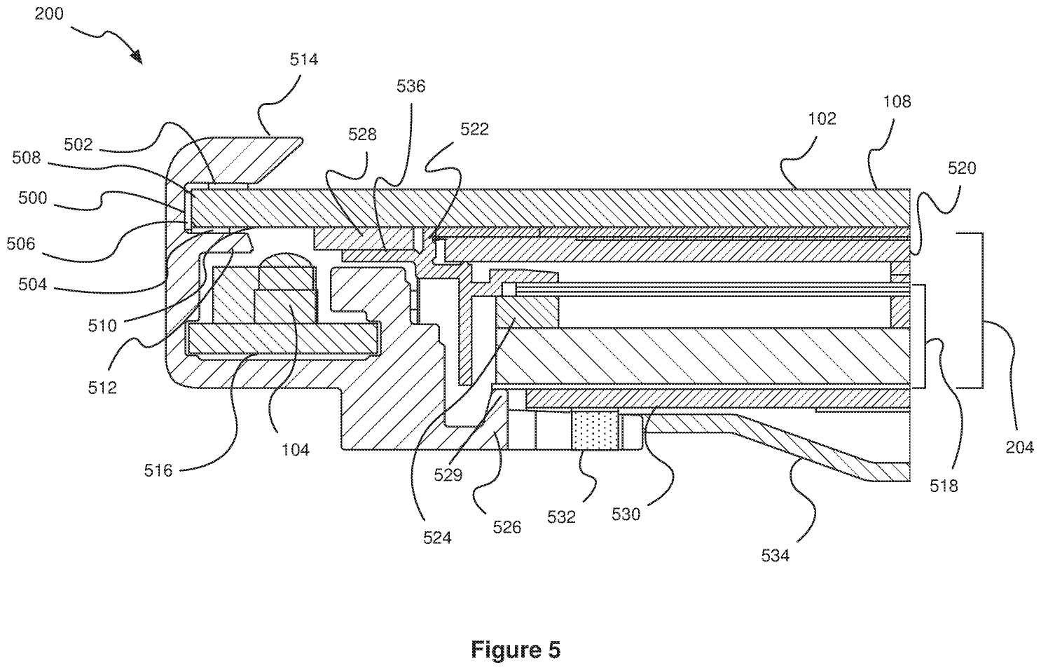

Turning to FIG. 5, the touch sensing display 200 will be described in more detail. FIG. 5 shows a partial cross-sectional view of the touch sensing display 200 according to an example. The cross-sectional view as shown in FIG. 5 is along axis E-E as shown in FIG. 3. The frame 300 is arranged to be a support structure for mounting all the components of the touch sensing display 200 and maintaining the relative position between the components.

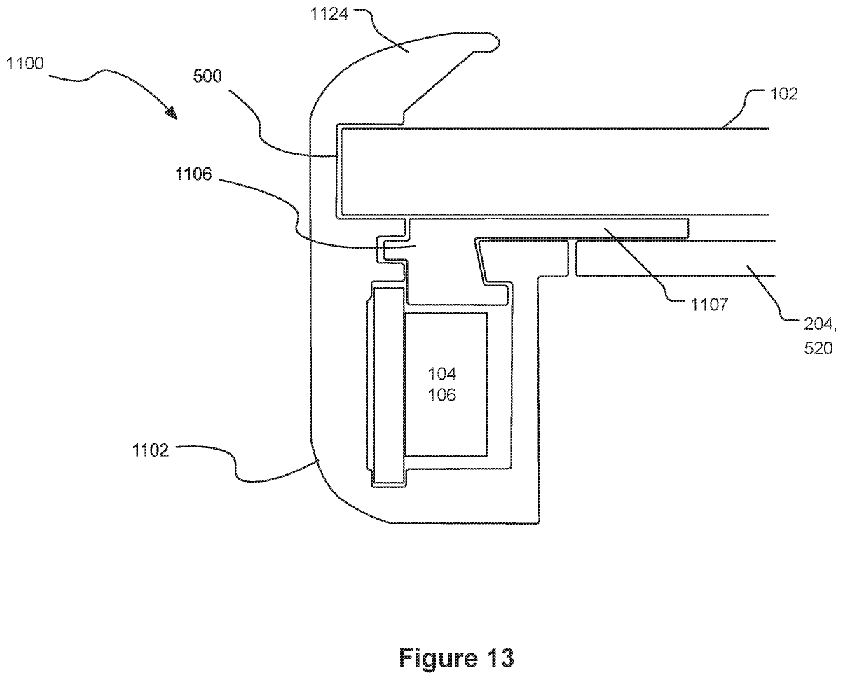

The frame 300 as shown in e.g. FIG. 5 and FIG. 13 comprises a touch panel slot 500 for receiving the touch panel 102. The touch panel slot 500 is arranged to engage the touch panel 102 on the touch surface 108, a side surface 508 and a rear surface 510 of the touch panel 102. The touch panel slot 500 may thus extend over the side surface 508 and at least partly over the touch surface 102, and at least partly over the rear surface 510. In some examples, the touch panel 102 is mounted in the touch panel slot 500 in the frame 300 via adhesive strips 502, 504, 506. The adhesive strips 502, 504, 506 are respectively adhered to the touch panel 102 on the touch surface 108, the side surface 508 and the rear surface 510. Since the frame 300 extends around the periphery 302 of the touch sensing display 200, the frame 300 engages the touch panel 102 around the entire periphery 302 of the touch panel 102.

In some examples, the touch panel slot 500 keeps the touch panel 102 fixed with respect to the frame 300. The frame 300 is then configured to support the load of the touch panel 102.

In some examples the touch panel 102 is not load bearing and does not support the weight of the touch sensing display 200 when the touch sensing display 200 is mounted on a surface.

However in some examples, the touch panel 102 is mounted within the touch panel slot 500 such that the touch panel 102 is able to support the weight of the touch sensing display 200 when the touch sensing display 200 is mounted on a surface. In order to enable the touch panel 102 to be load bearing, the touch panel 102 must be fixed, e.g. gripped, clamped, or adhered etc, sufficiently strongly to the frame 300. That is, a mounting force between the frame 300 e.g. the touch panel slot 500 and the touch panel 102 must exceed the force on the touch panel 102 when supporting the weight of the touch sensing display 200. In this case, if the mounting force exceeds the weight of touch sensing display 200, the touch panel 102 transmits the weight of the touch sensing display to the frame 300 without relative movement between the touch panel 102 and the frame 300.

In some examples, the adhesive strips 502, 504, 506 comprise an adhesive that permanently bonds the touch panel 102 in position within the touch panel slot 500. The bonding force between the frame 300 and the touch panel 102 allows the touch panel 102 to be load bearing. In some other examples, the walls 512, 514 of the touch panel slot 500 clamp against the touch surface 108 and the rear surface 510 of the touch panel 102. The clamping force of the walls 512, 514 of the touch panel slot 500 against the touch panel 102 means than the touch panel 102 can be load bearing. In some other examples, the touch panel 102 can be fastened to the frame 300 via a screw fastening (not shown) that is threaded through a hole (not shown) in the touch panel 102. The screw fastening then clamps the frame 300 against the touch panel 102. The clamping force of the screw fastening against the touch panel 102 means than the touch panel 102 can be load bearing. Optionally one or more of the adhesive, screw fastening or clamping can be used in combination.

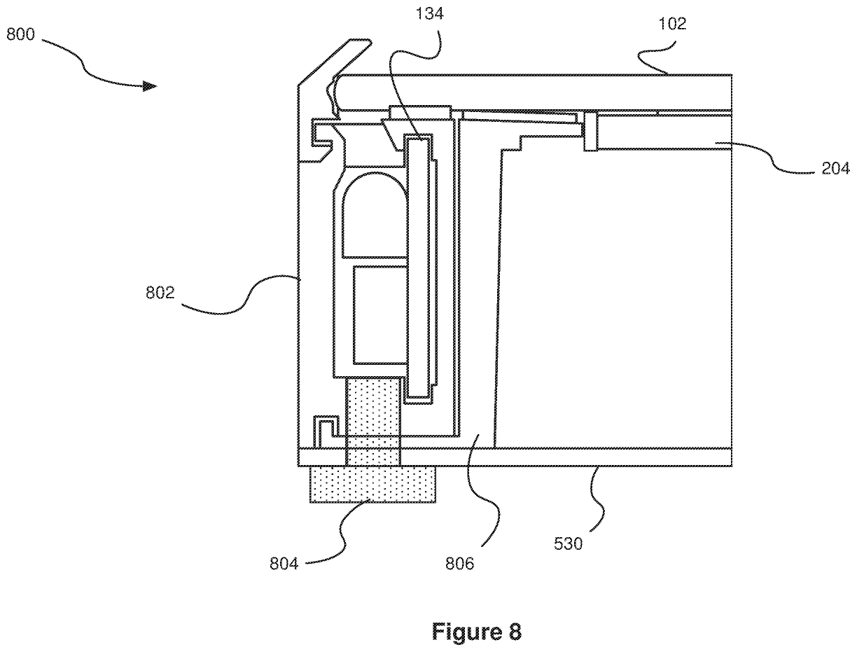

The frame 300 comprises a substrate slot 516 arranged to receive the substrate 134. As mentioned above, the substrate 134 comprises the optical emitters 104 and the optical detectors 106. The substrate slot 516 holds the substrate 134 fixed with respect the frame 300 and the touch panel 102. As shown in FIG. 5, the substrate 134 is arranged in a plane generally parallel with the plane of the touch panel 102. However, in some other examples the substrate 134 can be arranged in a plane perpendicular to the plane of the touch panel 102 (e.g. as shown in FIG. 8 which is discussed below). The substrate 134 can be mounted in any orientation as required within the substrate slot 516 within the frame 300.

In some examples the substrate 134 is positioned in the substrate slot 516 with a set screw (not shown). The set screw is arranged to engage a predetermined position on the substrate 134 and the set screw is threaded into a screw threaded hole 422 (best seen in FIG. 4) in the frame 300. The set screw means that the substrate 134 and the optical emitters 104 and the optical detectors 106 can be precisely aligned on the frame 300.

The display device 204 is integrated into the touch sensing display 200 and the display device 204 is mounted to the frame 300. The display device 204 comprises a display stack comprising a plurality of layers for generating and lighting an image. The composition of the display stack may comprise different layers depending on the type of display device 204. As shown in FIG. 5, the display device 204 comprises a back light assembly 518 and an open cell layer 520 e.g. an LCD pixels layer. The display device 204 is mounted behind the touch panel 102 and faces the rear surface 510 of the touch panel 102. The OC layer 520 is mounted between the back light assembly 518 and the touch panel 102. One or more gaskets 524 may be provided between the back light assembly 518 and the OC layer 520. The gasket 524 ensures that the OC layer 520 is held at a predetermined distance from the back light assembly 518.

In some examples, the OC layer 520 is mounted to the back light assembly 518 via a mounting element 522. The mounting element 522 is configured to grip the OC layer 520 and coupled to the back light assembly 518. In some examples, the mounting element is adhered to the rear surface 510 of the touch panel 102 and the back light assembly 518. This means that the OC layer 520 can be fixed in position with respect to the touch panel 102 and the back light assembly 518.

In some examples, the mounting element 522 is fixed to a blocker element 528. The blocker element 528 is opaque and prevents transmission of light between the optical emitters 104 and the display device 204. The blocker element 528 comprises a mounting surface 536 for adhering the mounting element 522 to. In this way, the blocker element 528 can also position the OC layer 520 with respect to the touch panel 102.

The frame 300 optionally comprises a projecting rear lip 526 which extends over a back side of the back light assembly 518. The projecting rear lip 526 engages the back light assembly 518 and keeps the back light assembly 518 and the OC layer 520 fixed with respect to the frame 300. In some examples, the projecting rear lip 526 comprises a ridge element 529 extending towards the rear surface 510 of the touch panel 102. The height of the ridge element 529 can be varied in order to position the display device 204 at the correct position from the touch panel 102. In some examples, the ridge element 529 can exert a clamping force towards the touch panel 102 against the back light assembly 518. This can help keep the back light assembly 518 in position with respect to the frame 300. Indeed, by providing a sufficiently high clamping force against the back light assembly 518, this can increase the internal strength of the touch sensing display 200. Furthermore, by providing a clamping force against the internal components such as the display apparatus 214, the internal components can be load bearing.

In some examples, there can be a plurality of projecting rear lips 526 comprises a ridge elements 529 each exerting a clamping force against different internal components. This can further increase the internal strength of the touch sensing display 200.

Optionally a back plate 530 is mounted to the frame 300 for protecting the internal components of the touch sensing display 200. In some examples, the back plate 530 is a sheet of metal such as aluminium or other suitable material. In some other examples, the back plate 530 is made from a lightweight material such as carbon fiber. The back plate 530 is fixed to the frame 300 via one or more back plate fixing screws 532. In some examples, the back plate 530 is a cover for protecting the internal components of the touch sensing display 200 and optionally is not load bearing.

The frame 300 comprises at least one surface mounting 534 configured to mount the touch sensing display 200 to a wall, a stand, or another upright surface. The at least one surface mounting 534 as shown in FIG. 5 may be a wall mounting bracket 534 configured to received and hold one or more fastenings for affixing the mounting bracket 534 to the wall. In some examples, the frame 300 comprises a single mounting bracket 534. However, in other examples, a plurality of mounting brackets 534 are fixed to the frame 300 to provide a plurality of mounting locations between the touch sensing display 200 and the wall. Optionally the mounting bracket 534 is slidable with respect to the frame 300 in order to adjust the mounting location with respect to the frame 300. The user is then able to clamp the mounting bracket 534 with respect to the frame 300 by tightening the back plate fixing screws 532 against the mounting bracket 534 before the mounting bracket 534 is fastened to the wall.

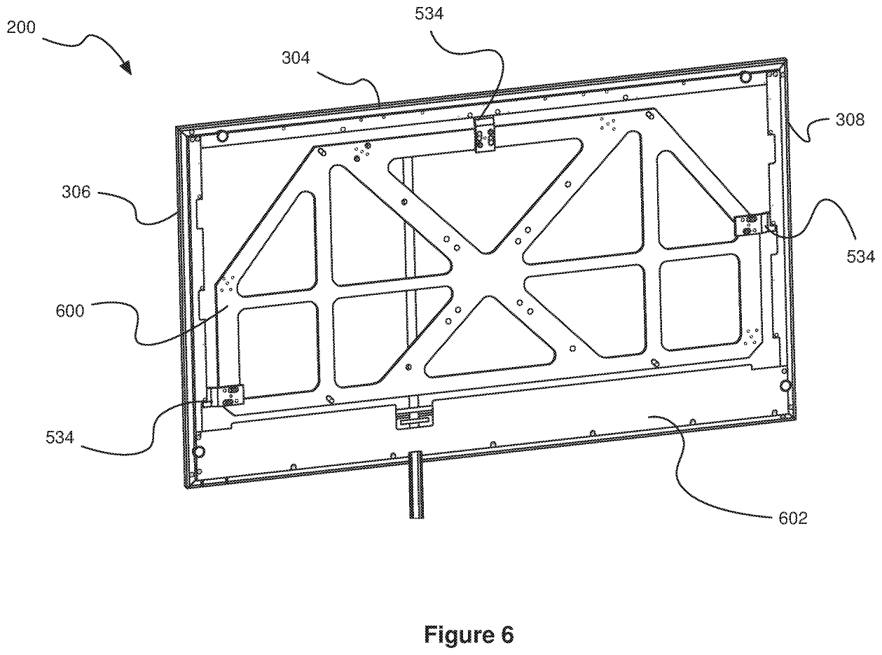

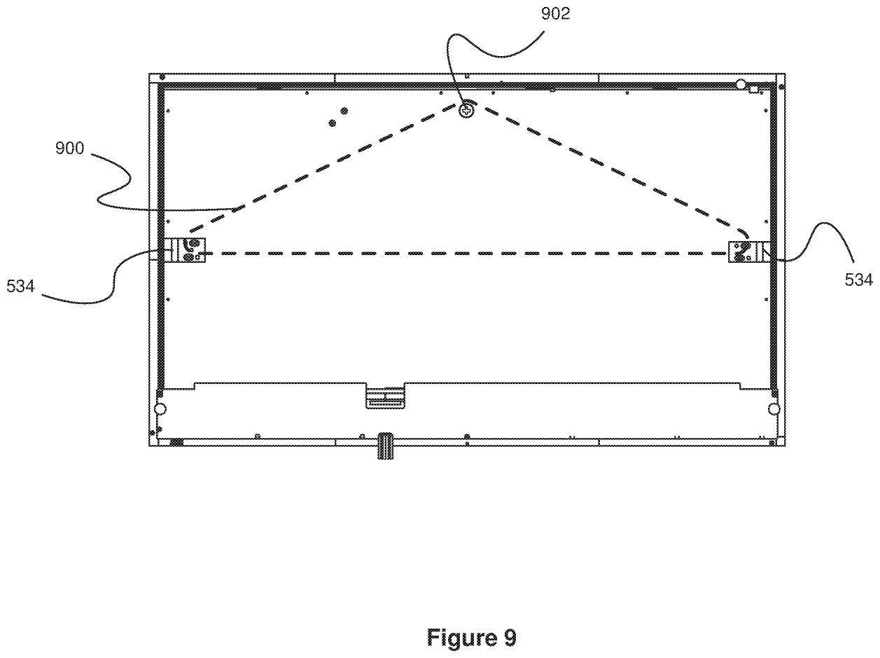

The arrangement of the mounting brackets 534 is shown in FIG. 9. FIG. 9 shows a rear view of a touch sensing display 200 according to an example. As can be seen from FIG. 9, there are a plurality of mounting brackets 534. In some examples, there can be two mounting brackets 534 as shown in FIG. 9. Alternatively, there can be three mounting brackets 534 as shown in FIG. 6. Indeed, there can be any number of mounting brackets 534 as required to provide the required number of mounting locations to securely fixed the touch sensing display 200 to the upright surface.

FIG. 9 shows that an optional hanging wire 900 is threaded between the mounting brackets 534. This means that the touch sensing display 200 can be hung from a single wall anchor 902 such as a bolt or screw anchored to the upright surface. Since the frame 300 is load bearing and can support the weight of the touch sensing display 200, the overall weight of the touch sensing display 200 is lighter because there is no need for a stiff and heavy back-mounted carrier mounted to the display apparatus 214. Accordingly, the touch sensing display 200 is light enough for a user to lift the touch sensing display 200 and hang the touch sensing display 200 on the upright surface like a picture frame.

In some other examples, the touch sensing display 200 is mounted directly to the upright surface via one or more mounting brackets 534.

In some examples as mentioned above, the back plate 530 is not load bearing and does not support the weight of the touch sensing display 200 when the touch sensing display 200 is mounted to the upright surface.

However, in other examples, the back plate 530 is load bearing and supports the weight of the touch sensing display 200 when the touch sensing display 200 is mounted to the upright surface. In some examples, the back plate 530 is mounted to the frame 300 via tensioning back plate fixing screw 532. In this way as the tensioning back plate fixing screw 532 is screwed into the back plate 530, the back plate 530 tensioned. Once the back plate 530 is sufficiently tensioned, the back plate 530 transmits the weight of the touch sensing display 200 without deforming. A plurality of tensioning back plate fixing screws 532 may be distributed along the frame 300 so to that the back plate 530 can be evenly tensioned in a plurality of directions. For example the back plate 530 may be tensioned in a direction parallel with the longitudinal axis A-A of the first frame part 304 and in a direction parallel with the longitudinal axis of e.g. the second or third frame parts 306, 308.

Additionally or alternatively, the frame 300 can be further tensioned by one or more tensioning connecting elements such as tension wires 1000, 1002 as shown in FIG. 10. FIG. 10 shows a rear view of the touch sensing display 200 according to an example. As shown in FIG. 10, there are a plurality of tensioning wires extending between the first and fourth frame parts 304, 310 and the second and third frame parts 306, 308. For the purpose of clarity only two tensioning wires 1000, 1002 have been labelled. However, there can be any number of tensioning wires 1000, 1002 mounted on the frame 300 between any two of the first, second, third and fourth frame parts 304, 306, 308, 310. Accordingly, the tensioning wires 1000, 1002 are arranged mounted between a first part of the frame 300 and a second part of the frame 300 and arranged to fix the first part of the frame 300 with respect to the second part of the frame 300. For example, the tensioning wires 1000, 1002 prevent the frame 300 from deforming outwards away from the touch panel 102. In some other examples, the tensioning connecting elements can be rods, struts, ribbons or any other suitable structure for exerting a tensioning force between different parts of the frame 300.

Alternative surface mountings 534 will now be discussed in reference to FIG. 6. FIG. 6 shows a rear perspective view of the touch sensing display 200 according to an example.

The touch sensing display 200 as shown in FIG. 6 is the same as discussed in reference to the other Figures. In addition, the touch sensing display 200 comprises a mounting adapter 600 coupled to the mounting brackets 534. The mounting adapter 600 is a lattice frame extending between the first, second and third frame parts 304, 306, 308. In some examples the mounting adapter 600 is a metal material such as aluminium or steel. The mounting adapter 600 provides one or more mounting positions in the middle of the touch sensing display 200. In some examples, the mounting adapter 600 is a VESA (Video Electronics Standards Association) compatible mounting adapter.

In some examples, the mounting adapter 600 is fixed directly to the frame 300 without the mounting brackets 534. For example, the mounting adapter 600 is welded, bonded, glued, clamped, screw fastened to the frame 300. In other examples, any suitable means can be used to fix the mounting adapter 600 to the frame 300. In some preferred examples, the mounting adapter 600 is screwed or bolted to the frame 300 so that the touch sensing display 200 can be more easily disassembled for maintenance.

In some examples, the mounting adapter 600 is mounted directly to the frame 300 with a plurality of tensioning back plate fixing screw 532. The mounting adapter 600 is then tensioned between the first frame part 304, the second frame part 306 the third frame part 308 and the fourth frame part 310. This is similar to the tensioning wires 1000, 1002 as mentioned above. In this way, the mounting adapter 600 can provide additional mounting positions and increase the strength of the touch sensing display 200.

As shown in FIG. 6, a lower back cover plate 602 can be mounted to the frame 300 below the position of the mounting adapter 600. The lower back cover plate 602 provides easy access to some internal components for improving accessibility during installation and maintenance.

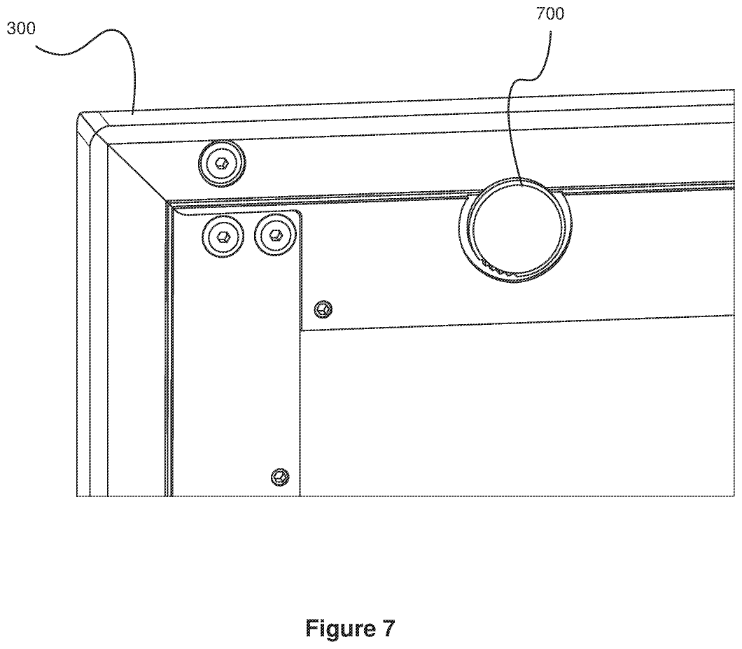

FIG. 7 shows a partial perspective view of the touch sensing display 200 according to an example. In some examples, the frame 300 comprises a wall perimeter control knob 700. The wall perimeter control knob 700 is for controlling the relative distance of the touch sensing display 200 from the upright surface. For example, the wall perimeter control knob 700 is mounted to the frame 300 via a screw thread and the wall perimeter control knob 700 projects from the surface of the frame 300 towards the upright surface. The wall perimeter control knob 700 is arranged to engage the upright surface when the touch sensing display 200 is mounted on the upright surface. This can help securely mount the touch sensing display 200 on the upright surface because the touch sensing display 200 is mounted parallel with the upright surface.

Accordingly the wall perimeter control knob 700 in some examples, engages the upright surface and exerts a force on the frame 300. The wall perimeter control knob 700 is arranged to selectively deform the frame 300 in a localised area of the frame 300. In some examples, a plurality of wall perimeter control knobs 700 are mounted on each of the first frame part 304, the second frame part 306, the third frame part 308 and the fourth frame part 310. In some examples, there can be any number of wall perimeter control knobs 700 mounted on the frame 300. The one or more wall perimeter control knobs 700 can be used to twist and bend the frame 300 into the correct position when mounted on the upright surface.

Turning to FIG. 8 another example will now be discussed. FIG. 8 shows a partial cross sectional view of a touch sensing display 800 according to an example. The touch sensing display 800 is similar to the previously discussed touch sensing displays 200 except that the arrangement of the internal components is different. In the example as shown in FIG. 8, the back plate 530, the touch panel 102 and the frame 802 are all load bearing.

A display holder 806 is configured to retain the display device 204 and the display holder 806 is clamped to the frame 802 by one or more fastenings 804. The back plate 530, the touch panel 102 and the frame 802 are clamped together by one or more fastenings 804. As previously mentioned, clamping the back plate 530, the touch panel 102 and the frame 802 allows all the parts to load bearing whilst fixing their relative positions in the touch sensing display 800.

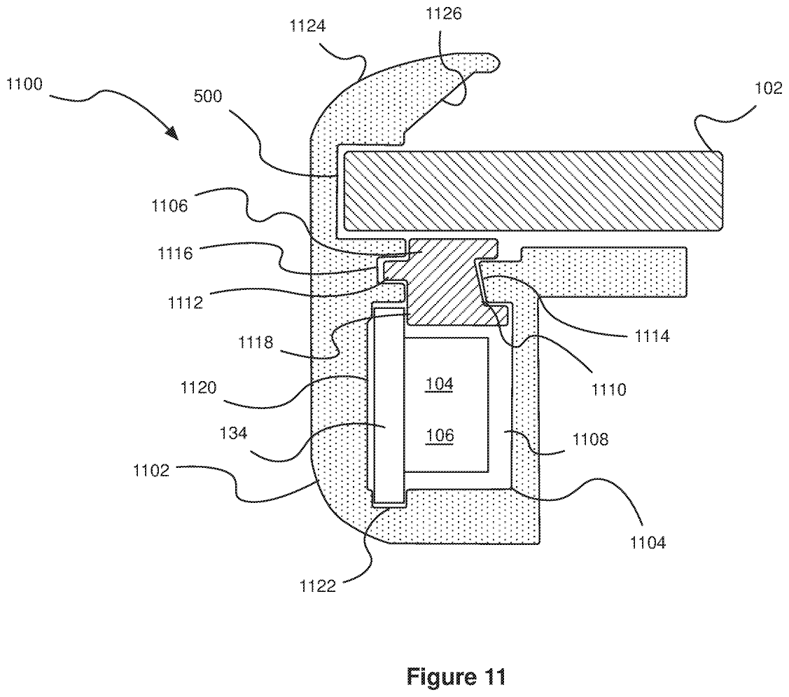

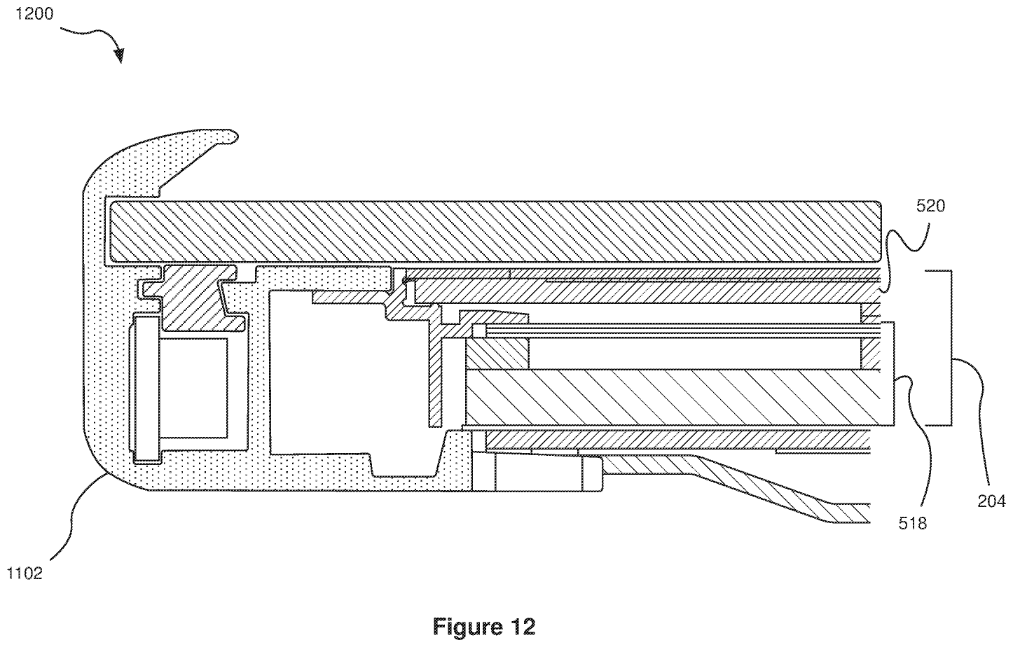

Turning to FIGS. 11 and 12, another example will now be described. FIG. 11 shows a partial cross sectional view of a touch sensing apparatus 1100 according to an example. FIG. 12 shows a partial cross sectional view of a touch sensing display 1200 according to an example.

The touch sensing apparatus 1100 as shown in FIG. 11 is the same as shown in the previous examples except that the position and arrangement of the components of the touch sensing apparatus 1100 has been modified. The touch sensing apparatus 1100 as shown in FIG. 11 can be used together in a touch sensing display 1200 e.g. as shown in FIG. 12. The touch sensing display 1200 as shown in FIG. 12 has a similar functionality as the touch sensing display 200, 800 as discussed with respect to the previous examples. That is, a frame 1102 is arranged to be load bearing and support the weight of the touch sensing display 1200 when mounted on an upright surface.

Indeed, as shown in FIG. 12, the display device 204 comprising a back light assembly 518 and the open cell layer 520 e.g. an LCD pixels layer as the same as discussed with the previous examples.

As mentioned above and as shown in FIGS. 11 and 12, the frame 1102 is load bearing and supports the weight of the touch sensing display 1200 when the touch sensing display 1200 is mounted on an upright surface. However, in some other examples, the touch sensing apparatus 1100 can be used in a frame 1102 which is not load bearing. In this example, the touch sensing apparatus 1100 can be mounted on a display device 204 mounted on a load bearing display device carrier (not shown).

The frame 1102 comprises a unitary structure with a touch panel slot 500 as discussed above. The frame 1102 comprises a channel 1104 for receiving one or more components. The channel 1104 is an open channel 1104 and configured to receive the substrate 134 in some examples. The optical emitters 104 and the optical detectors 106 are mounted on the substrate 134 and located in the channel 1104. In this way, the examples shown in FIGS. 11 and 12 show an above surface optical touch system.

A sealing guide 1106 is mountable in the channel 1106 and configured to seal the channel 1104 when the sealing guide 1106 is mounted in the channel 1104. This means that the channel 1104 and the sealing guide 1106 define a cavity 1108 when the sealing guide 1106 is mounted to the channel 1104. The sealing guide 1106 engages against the frame 1102 and prevents the ingress of dirt and debris into the cavity 1108. This means that the substrate 134 can be protected and remains clean during use.

In some examples, the sealing guide 1106 when mounted in the channel 1104 protects the cavity 1108 from limited dust ingress or protects the cavity 1108 from total ingress. In this way, the sealing guide 1106 and the channel 1104 can provide an International Protection (IP) rating of IP5X or IP6X for the substrate 134 within the cavity 1108.

The sealing guide 1106 comprises a slot 1110 and rail 1112 arranged to respectively engage with a reciprocal rail 1114 and a reciprocal slot 1116 arrangement on the frame 1102. Accordingly, the sealing guide 1106 can be slid into the engagement with the reciprocal rail 1114 and the reciprocal slot 1116 on the frame 1102 during assembly. Alternatively, the sealing guide 1106 can comprise a snap fit engagement (not shown) with the frame 1102. Additionally or alternatively, the sealing guide 1106 is adhered to the frame 1102 when mounted to the frame 1102.

In some examples, the sealing guide 1106 is optionally light transmissive and mounted between the plurality of optical emitters 104 and optical detectors 106 and the touch panel 102. In this way light can propagate through the sealing guide when being emitted by the optical emitters 104 or being detected by the optical detectors 106. The light can be visible light, infrared light (IR) and/or ultraviolet (UV) light. In other examples the optical emitters 104 and optical detectors 106 can be respectively configured to emit and detect any frequency of electromagnetic radiation. In some examples, as shown in FIG. 11, the sealing guide 1106 is configured to be transmissive for infrared light but prevents the transmission of visible wavelengths.

As shown in FIG. 11, the sealing guide 1106 is mounted above the plurality of optical emitters 104 and optical detectors 106. However, in some other examples, the sealing guide 1106 is not mounted between the plurality of optical emitters 104 and optical detectors 106 and the touch panel 102. In this example, the light path between plurality of optical emitters 104 and optical detectors 106 does not pass through the sealing guide 1106. Accordingly, sealing guide 1106 does not need to be light transmissive.

Once the sealing guide 1106 is mounted to the frame 1102, the sealing guide 1106 optionally comprises a shoulder portion 1118 that projects in to the cavity 1108. The shoulder portion 1118 is arranged to the substate 134 when the sealing guide 1106 is mounted in the channel 1104. The shoulder portion 1118 is arranged to urge the substrate 134 against one or more channel walls 1120. In some examples, the shoulder portion 1118 and the channel walls 1120 define a substrate slot 1122 arranged to receive the substrate 134. The substrate 134 is held in the substrate slot 1122 similar to the previously described examples.

The frame 1102 comprises an upper projecting lip 1124 which projects inwards to the the centre of the touch panel 102. The upper projecting lip 1124 comprises an edge reflector/diffusor 1126 arranged to guide the light above the touch panel 102. The edge reflector/diffusor 1126 is positioned above the sealing guide 1106 and the optical emitters 104 and optical detectors 106.

The sealing guide 1106 may comprise an elongated extension 1107 which extends in parallel with the touch panel 102, and between the frame 1102 and the touch panel 102, as schematically illustrated in FIG. 13. The elongated extension 1107 may provide for additional support for the touch panel 102 and a further improved fixation thereof to the frame 1102. The elongated extension 1107 may extend in parallel with the touch panel 102 to at least partly overlap the display device 204, such as the open cell (OC) layer 520.

The sealing guide 1106 including the elongated extension 1107 prevents the transmission of visible wavelengths, but is transmissive for infrared light. The sealing guide 1106 including the elongated extension 1107 thus provides an opaque border along edges of the touch panel 102, along the periphery of the touch panel 102. The opaque border extends in a direction parallel with the touch panel 102 between the display device 204, e.g. the OC layer 520, and the bezel of the frame 1102, such as the upper projecting lip 1124 of the frame 1102. The sealing guide 1106 with the elongated extension 1107 can thus replace e.g. black paint which is otherwise utilized to provide an opaque border along edges of the touch panel 102, between the display device 204 and the visible part of the frame 1102, i.e. the bezel as exemplified by projecting lip 1124 in FIG. 13.

Similar to the examples, shown in FIG. 8, the substrate 134 as shown in FIG. 11 is mounted in a vertical plane e.g. a plane perpendicular to the plane of the touch panel 102. However, the substrate 134 can be mounted in a plane parallel to the plane of the touch panel 102 in the channel 1104 in a similar orientation to the examples as shown in FIG. 5.

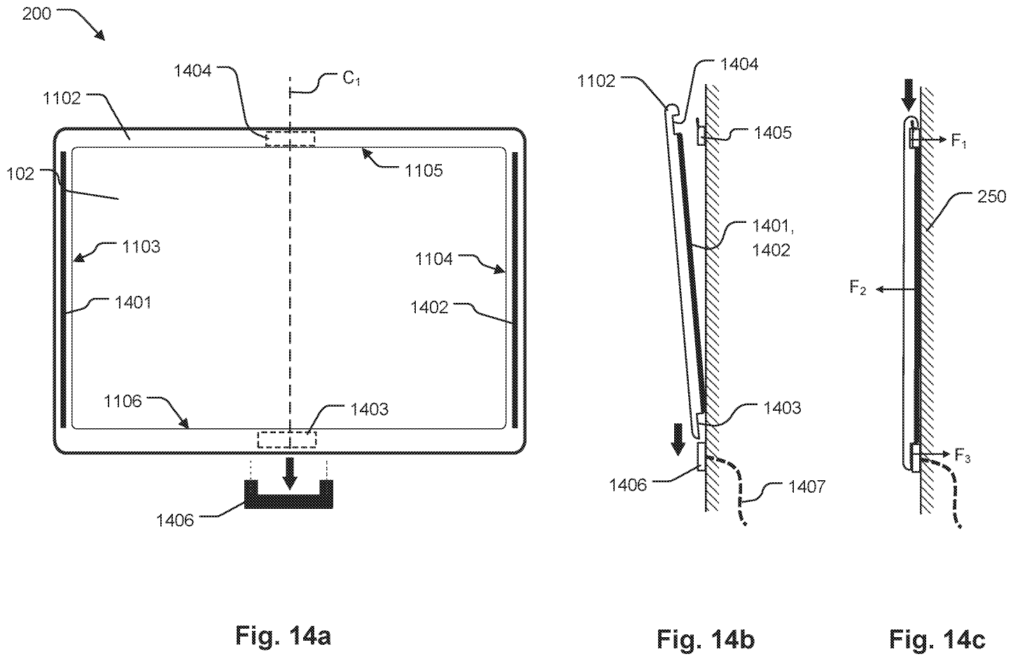

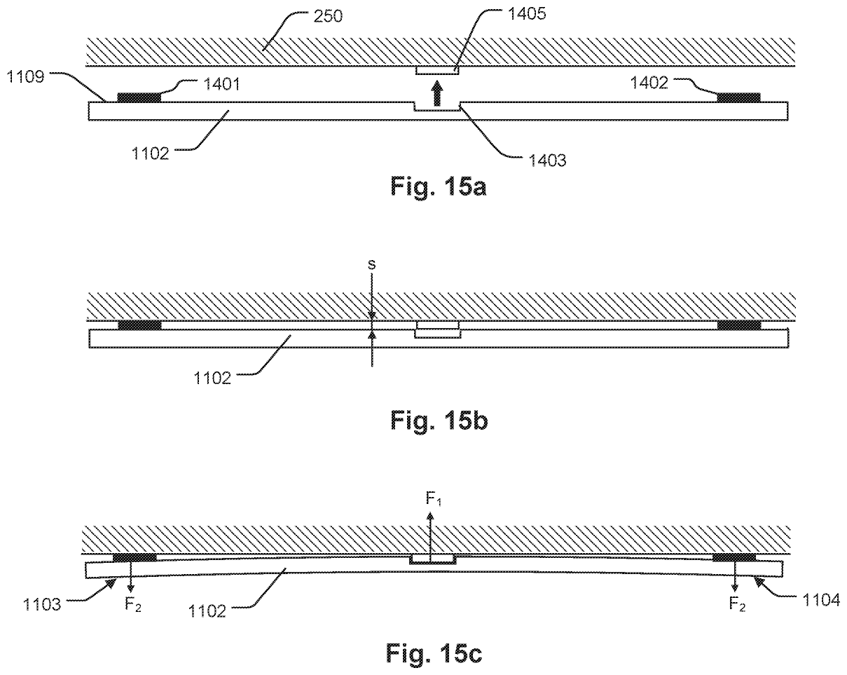

The touch sensing display 200 may comprise first and second supports 1401, 1402, arranged along opposite first and second sides 1103, 1104, of the frame 1102, as schematically illustrated in FIG. 14a. The touch sensing display 200 may comprise first and second attachment guides 1403, 1404, configured to interlock with corresponding first and second wall anchors 1405, 1406, as further schematically illustrated in FIGS. 14b-c. The first and second supports 1401, 1402, are pinched between the mounting surface 250, such as a wall, and the frame 1102 when the first and second attachment guides 1403, 1404, interlock with the first and second wall anchors 1405, 1406, as exemplified in FIG. 14c. FIGS. 15a-c are corresponding top-down views showing the first and second supports 1401, 1402, pinched between the mounting surface 250 and the frame 1102 when attachment guide 1403 interlock with the wall anchors 1405. The first and second supports 1401, 1402, are configured to apply a force (F₂) onto the opposite first and second sides 1103, 1104, of the frame 1102 while the first and second attachment guides 1403, 1404, interlock with the first and second wall anchors 1405, 1406, and thereby pull the frame 1102 inwards towards the mounting surface 250 as indicated in FIG. 15c with a force F₁. The frame 1102, and the touch panel 102 held by the frame 1102, may thus be bent in a slightly concave shape which is advantageous in some applications. Having a frame 1102 which is load bearing for the touch panel 102 as described above provides for an advantageously thin touch sensing display 200, which in combination with first and second supports 1401, 1402, and first and second attachment guides 1403, 1404, provides for a facilitated manipulation of the curvature of the touch panel 102, such as providing for the aforementioned concave curvature.

FIG. 14a shows an example where the first and second attachment guides 1403, 1404, are arranged at top and bottom portions 1105, 1106, of the frame 1102, and at midpoints thereof, in order to pull the frame 1102 towards the mounting surface 250 along a vertical center axis C₁ (see also force F₁, F₃, in the side view of FIG. 14c). The frame 1102 may thus be curved around the vertical center axis C₁.

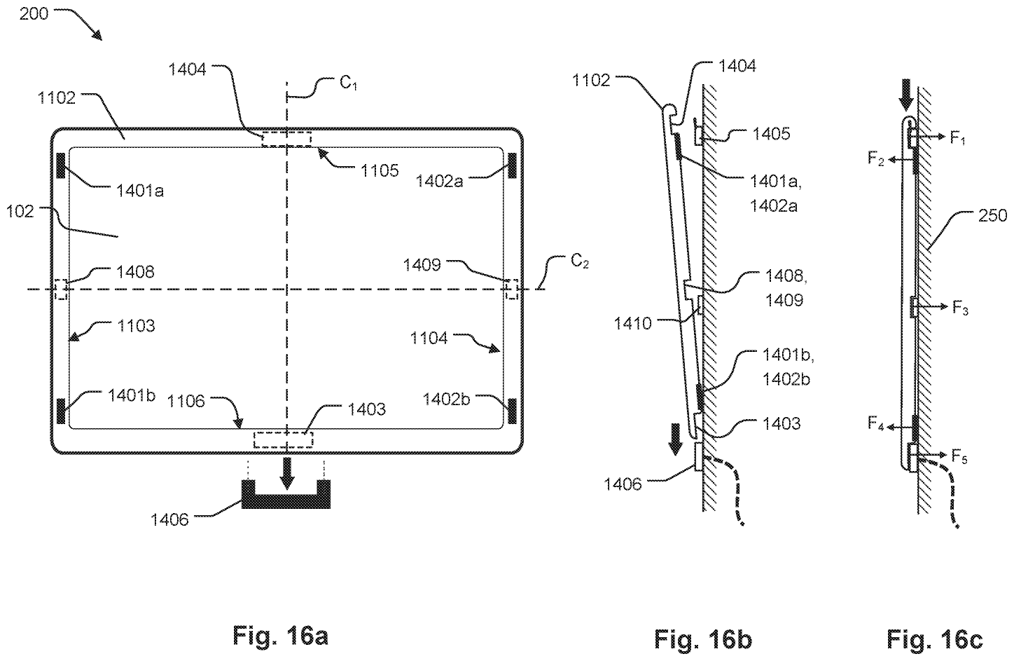

FIGS. 16a-c show an example where the frame 1102 is curved around the vertical center axis C₁, and around a horizontal center axis C₂. First upper and lower supports 1401a, 1401b, are arranged along a first side 1103 of the frame 1102. Second upper and lower supports 1402a, 1402b, are arranged along a second side 1104 of the frame 1102, opposite the first side 1103. The supports 1401a, 1401b, 1402a, 1402b, may be arranged adjacent the corners of the frame 1102. Attachment guides 1403, 1404, are arranged at top and bottom portions 1105, 1106, of the frame 1102, along the vertical center axis C₁. Attachment guides 1408, 1409, are arranged at the first and second sides 1103, 1104, of the frame 1102, along the horizontal center axis C₂. Attachment guides 1408, 1409, are configured to interlock with respective wall anchors, generally denoted 1410 in the side-view of FIG. 16b. The frame 1102 is pulled towards the mounting surface 250 at the positions of the attachment guides 1403, 1404, 1408, 1409 (indicated in the side view of FIG. 16c by force F₁, F₃, F₅), and the supports 1401a, 1401b, 1402a, 1402b, push on the frame 1102 at corresponding positions (indicated in the side view of FIG. 16c by force F₂, F₄), so that the frame 1102 and touch panel 102 may curve in a concave shape along the vertical center axis C₁, and the horizontal center axis C₂.

Thus, the touch sensing display 200 may comprise first and second supports 1401, 1402 (e.g. any of 1401, 1401a, 1401b, 1402, 1402a, 1402b), arranged along opposite sides 1103, 1104, 1105, 1106, of the frame 1102 and on a back portion 1109 of the opposite sides 1103, 1104, 1105, 1106, to be facing a mounting surface 250 (such as wall) for the touch sensing display 200. The first and second supports 1401, 1402, project from the back portion 1109 so that a spacing (s) is formed between the frame 1102 and the mounting surface 250 when the first and second supports 1401, 1402, are placed in abutment with the mounting surface 250 (see FIG. 15b). The touch sensing display 200 may comprise at least one attachment guide 1403, 1404, 1408, 1409, configured to interlock with a respective wall anchor 1405, 1406, 1410, to pull the frame 1102 towards the mounting surface 250, whereby the spacing (s) is reduced and the first and second supports 1401, 1402, push on the opposite sides 1103, 1104, 1105, 1106, so that the frame 1102 curve inwards towards the mounting surface 250.

Any of the attachment guides 1403, 1404, 1408, 1409, may comprise an electrical connection interface for connection with data communication and/or outlet power, e.g. via data/power cable 1407, via any of the wall anchors 1405, 1406, 1410, see e.g. FIG. 14b. Any of the attachment guides 1403, 1404, 1408, 1409, may interlock with a respective wall anchor 1405, 1406, 1410, via a snap-fit connection for facilitated mounting.

In another example, two or more examples are combined. Features of one example can be combined with features of other examples.

Examples of the present disclosure have been discussed with particular reference to the examples illustrated. However it will be appreciated that variations and modifications may be made to the examples described within the scope of the disclosure.

1. A touch sensing display comprising:
a frame comprising at least one surface mounting;
a panel defining a touch surface on a first side and being mounted to the frame around a periphery of the panel;
at least one touch detector configured to detect a touch event on the touch surface; and
a display apparatus mounted to the frame and facing rear surface on a second side of the panel, the display apparatus being configured to receive a touch event signal from the at least one touch detector;
wherein the frame is load bearing and arranged to support the weight of the touch sensing display when the at least one surface mounting is attached to a surface.

2. A touch sensing display according to claim 1 wherein the panel is fixed to the frame and both the frame and the panel are load bearing and arranged to support the weight of the touch sensing display when the at least one surface mounting is attached to the surface.

3. A touch sensing display according to claim 2 wherein the panel is fixed to the frame along a periphery of the panel and on the rear surface on the second side of the panel.

4. A touch sensing display according to claim 1, wherein the frame comprises a touch panel slot extending along the periphery of the panel and being configured to receive the panel and fix the panel with respect to the frame.

5. A touch sensing display according to claim 4, wherein the panel comprises a side surface extending between the touch surface and the rear surface, wherein the touch panel slot extends over the side surface and at least partly over the touch surface and at least partly over the rear surface.

6. A touch sensing display according to claim 1, comprising first and second supports arranged along opposite sides of the frame and
on a back portion of the opposite sides to be facing a mounting surface for the touch sensing display,
wherein the first and second supports are projecting from the back portion so that a spacing is formed between the frame and the mounting surface when the first and second supports are placed in abutment with the mounting surface,
at least one attachment guide configured to interlock with a wall anchor to pull the frame towards the mounting surface, whereby the spacing is reduced and the first and second supports push on the opposite sides so that the frame curve inwards towards the mounting surface.

7. A touch sensing display according to claim 1 wherein a back plate is mounted to the frame such that the display apparatus is between the panel and the back plate.

8. A touch sensing apparatus according to claim 7 wherein the back plate is fixed to the frame and both the frame and the back plate are load bearing and arranged to support the weight of the touch sensing display when the at least one surface mounting is attached to the surface.

9. A touch sensing display according to claim 7 wherein the frame and/or the back plate is made from carbon fibre and/or aluminum.

10. A touch sensing display according to claim 1 wherein at least one tensioning connecting element is mounted between a first part of the frame and a second part of the frame and arranged to fix the first part of the frame with respect to the second part of the frame.

11. A touch sensing display according to claim 10 wherein the first part of the frame and the second part of the frame are positioned on different sides of the frame.

12. A touch sensing display according to claim 1 wherein the frame comprises a projecting lip configured to engage the one or more internal components and the projecting lip is configured to clamp the one or more internal components against the touch panel.

13. A touch sensing display according to claim 12 wherein one or more internal components are the display apparatus and/or the at least one touch detector.

14. A touch sensing display according to claim 1 wherein the at least one touch detector is a plurality of light emitters and detectors arranged along a perimeter of the panel and the light emitters are arranged to emit a respective beam of emitted light above the touch surface, and the light emitters are arranged to receive detection light from the emitted light.

15. A touch sensing display according to claim 14 wherein the plurality of touch detectors are mounted on a substrate and the substrate is mounted within a slot in the frame.

16. A touch sensing display according to claim 1 wherein the at least one touch detector is a projected capacitive touch assembly.

17. A touch sensing display according to claim 1 wherein the at least one surface mounting comprises a mounting bracket fixed to the frame.

18. A touch sensing display according to claim 17 wherein the mounting bracket comprises one or more mounting positions for receiving a fastening and/or a hanging cable.

19. A touch sensing display according to claim 17 wherein the mounting bracket is a VESA mounting adapter.

20. A touch sensing apparatus according to claim 1 wherein the surface is an upright surface.

21. A touch sensing display wherein the frame comprises at least one interlocking corner comprising a first interlocking corner part and a second interlocking corner part.

22. A touch sensing display according to claim 21 wherein the first interlocking corner part and the second interlocking corner parts each comprise at least one first engagement surface in a first plane and at least one second engagement surface in a second plane perpendicular to the first plane.

23. A touch sensing display according to claim 21 wherein the first interlocking corner part and the second interlocking corner part each comprise a first overlapping tab and a second overlapping tab wherein the first overlapping tab is on a front facing side of the frame and the second overlapping tab is positioned on a rear facing side of the frame.

24. A touch sensing display according to claim 21 wherein the first interlocking corner part and the second interlocking corner part comprise at least one hole for receiving one or more locking fasteners therethrough.

25. A touch sensing apparatus, comprising:
a frame comprising at least one surface mounting;
a panel defining a touch surface on a first side and being mounted to the frame around a periphery of the panel;
at least one touch detector configured to detect a touch event on the touch surface; and
at least one a display apparatus mounting fixed to the frame and configured to mount a display apparatus to the frame and facing rear surface a second side of the panel, the display apparatus being configured to receive a touch event signal from the at least one touch detector;
wherein the frame is load bearing and arranged to support the weight of the touch sensing apparatus when the at least one surface mounting is attached to a surface.

26. A touch sensing apparatus comprising:
a frame having a channel;
a panel defining a touch surface on a first side and being mounted to the frame above the channel around a periphery of the panel;
a plurality of light emitters and detectors arranged along a perimeter of the panel and the light emitters are arranged to emit a respective beam of emitted light above the touch surface, and the light emitters are arranged to receive detection light from the emitted light;
a substrate on which the plurality of light emitters and detectors are mountable wherein the substrate is mountable in the channel; and
a sealing guide mountable in the channel and configured to seal the channel.

27. A touch sensing apparatus according to claim 26 wherein the sealing guide is light transmissive and mounted between the plurality of light emitters and detectors and the panel.

28. A touch sensing apparatus according to claim 26 wherein the sealing guide is arranged to engage the substate when mounted in the channel.

29. A touch sensing apparatus according to claim 28 wherein the sealing guide is arranged to urge the substrate against one or more walls of the channel when mounted in the channel.

30. A touch sensing apparatus according to claim 26 wherein the sealing guide comprises a slot and rail arranged to respectively engage with a reciprocal rail and slot arrangement on the frame.

31. A touch sensing apparatus according to claim 26 wherein the sealing guide comprises an elongated extension, wherein the elongated extension extends in parallel with the touch panel, between the frame and the touch panel.
